(19) United States
(12) Patent Application Publication
(10) Pub. No.: US 2026/0364958 A1
(43) Pub. Date: Nov. 19, 2026

(54) IMAGE FORMING SYSTEM

(71) Applicant: KYOCERA DOCUMENT SOLUTIONS INC., OSAKA (JP)

(72) Inventor: HISAJI KAWAI, OSAKA (JP)

(21) Appl. No.: 19/670,012

(22) Filed: May 7, 2026

(30) Foreign Application Priority Data
May 13, 2025 (JP) 2025-080255

(51) Int. Cl. B41J 11/00; B41J 29/377

(52) U.S. Cl. CPC B41J 11/00212; B41J 11/00218; B41J 11/006; B41J 11/007; B41J 29/377

(57) ABSTRACT

An image forming system includes an image forming apparatus and a drying apparatus. The drying apparatus includes a transportation unit and a drier body that is movable by a movement mechanism such that a drying space is formed when the drier body is situated at a first position and such that the space is made open when the drier body is situated at a second position. A controller of the drying apparatus generates a drive signal used to move the drier body. When a temperature in the drying space is greater than or equal to a threshold, the controller performs a process of disabling the drive signal.

### CROSS-REFERENCE TO RELATED PATENT APPLICATION

This application claims the benefit of Japanese Priority Patent Application JP 2025-080255 filed May 13, 2025, the entire contents of which are incorporated herein by reference.

### FIELD OF THE DISCLOSURE

The present disclosure relates to an image forming system.

### BACKGROUND OF THE DISCLOSURE

There is a general-purpose printer in which, when a paper jam occurs during drying of ink ejected onto a sheet, a drying unit is moved in a direction of being more distant from a transportation path for a sheet, such that a jammed sheet can be removed. The movement of the drying unit results in making a drying space between the transportation path and the drying unit open to make room. This enables a user to place his/her hand into the transportation path to remove the jammed sheet.

Note that, typically, a technology is known that moves a drying apparatus up and down with respect to a transportation path in order to prevent an increase in a temperature of a sheet stopped in the transportation path.

### SUMMARY OF THE DISCLOSURE

An image forming system according to an embodiment of the present disclosure includes an image forming apparatus that forms an image on a sheet, and a drying apparatus that dries ink ejected onto the sheet. The drying apparatus includes a transportation unit, a drying unit, a position detector, a temperature detector, and a controller. The transportation unit transports, along a transportation path, the sheet on which the image has been formed. The drying unit includes a drier body and a movement mechanism. The drier body has a heat source built in. A drying space used to dry the sheet is formed between the drier body and the transportation unit when the drier body is situated at a first position. The drying space is made open when the drier body is situated at a second position. The movement mechanism moves the drier body between the first position and the second position. The position detector is installed near the drying space, and detects a position of the drier body. The temperature detector detects a temperature in the drying space. The controller is capable of generating, upon acquiring an external signal, a drive signal used to move the drier body from the first position to the second position. When the temperature in the drying space is greater than or equal to a specified threshold, the controller performs a disabling process to disable output of the drive signal.

### BRIEF DESCRIPTION OF THE DRAWINGS

FIG. 1 illustrates an example of an overall configuration of an image forming system.

FIG. 2 schematically illustrates an internal configuration of a drying apparatus.

FIG. 3 schematically illustrates the internal configuration of the drying apparatus.

FIG. 4 illustrates an example of an internal configuration of a controller.

FIG. 5 illustrates an example of the controller according to a modification.

FIG. 6 is a flowchart of an example of a process of controlling the drying apparatus.

### DETAILED DESCRIPTION OF THE EXEMPLARY EMBODIMENTS

There is a drying unit that includes a position sensor that detects a position of a drier body. For example, the position sensor is installed near a transportation path in order to detect the position of the drier body. Thus, when a drying space is made open in response to the operation of moving the drying unit, the position sensor may be damaged by being subjected to a high-temperature air flowing out of a drying space. Therefore, there are demands for a technology that can move a drying unit in order to prevent a sensor situated near a transportation path from being damaged.

In view of the circumstances described above, the present disclosure makes it possible to provide an image forming system that prevents a sensor situated near a drying space formed between a drying unit and a transportation path from being damaged even when the drying space is made open.

Hereinafter, embodiments of the present disclosure will be described with reference to the drawings.

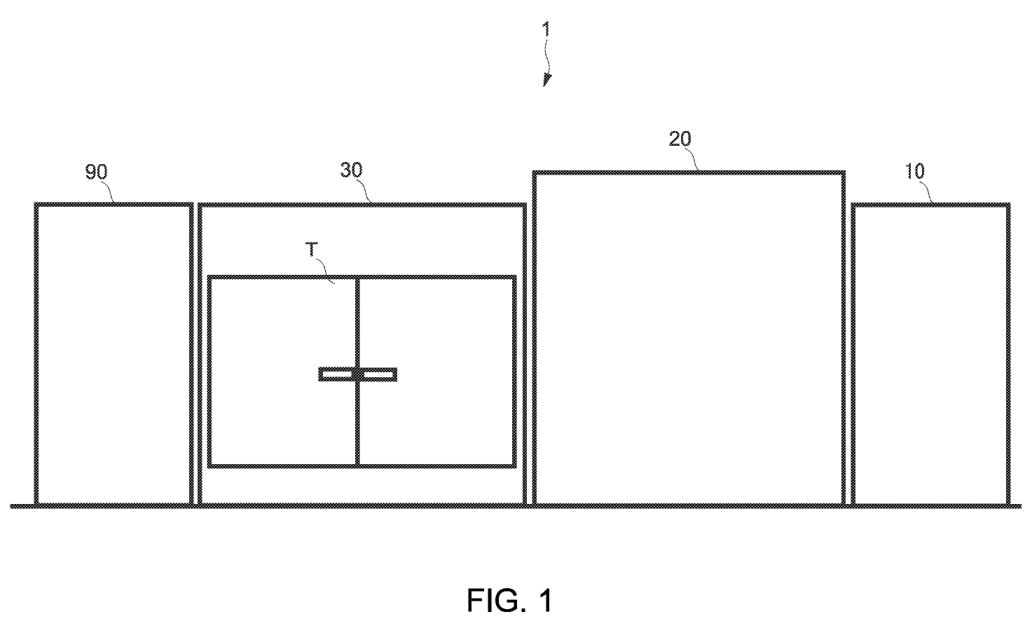

FIG. 1 illustrates an example of an overall configuration of an image forming system 1 according to the present embodiment. As illustrated in the figure, the image forming system 1 includes a sheet feeding apparatus 10, a printer 20, a drying apparatus 30, and a post-processing apparatus 90.

For example, the sheet feeding apparatus 10 is an apparatus that includes a large-capacity accommodation portion capable of accommodating therein thousands of sheets, and that supplies the sheet to the printer 20. The printer 20 is an ink-jet image forming apparatus that ejects ink onto a sheet to form an image. The drying apparatus 30 is an apparatus that heats to dry ink ejected onto a sheet. The post-processing apparatus 90 is an apparatus that performs post-processes such as punching, binding by stapling, and folding with respect to sheets.

Next, the printer 20 (an image forming apparatus) is described in detail. The printer 20 includes a rectangular-parallelepiped-shaped body housing, and a sheet cassette and a sheet feeding roller are provided in the body housing. The sheet cassette accommodates therein flat sheets such as plain paper and coated paper, and the sheet feeding roller feeds the sheet from the sheet cassette.

Further, a transportation unit that pulls a sheet by suction to transport the sheet to the drying unit is provided in the body housing. Further, an imaging unit and an ink container are provided in the body housing. The imaging unit includes a plurality of ink-jet heads, and the ink container supplies ink to the imaging unit.

Further, a discharge roller and a discharge exit are provided in the body housing, where the discharge roller discharges a sheet on which an image is formed, and the sheet is discharged toward the drying unit through the discharge exit. Further, a transportation path that extends from the sheet cassette to the discharge exit via the transportation unit is provided in the body housing. Furthermore, a plurality of transportation rollers transporting a sheet is provided to the transportation path. Further, a resist roller is provided upstream of the imaging unit in a transportation direction (on the side of the sheet feeding apparatus 10).

Next, a basic image forming operation performed by the printer 20 is described. When an image forming job is input to the printer 20 by, for example, an external computer, the sheet feeding roller feeds a sheet to the transportation path from the sheet cassette, and the resist roller corrects skewing of the sheet. Further, when the resist roller feeds the sheet to the transportation unit at a specified timing, the transportation unit pulls the sheet to the transportation belt by suction to transport the sheet to the drying unit.

Further, when grayscale data corresponding to a nozzle of each ink-jet head is supplied to a drive circuit in synchronization with transportation of a sheet, the drive circuit supplies a drive signal corresponding to the grayscale data to a voltage element. This results in ink drops being ejected from the nozzle. Accordingly, an image is formed on the sheet. Further, the sheet on which the image has been formed is discharged toward the drying unit through the discharge exit.

Note that a controller causes the sections of the image forming system 1 to perform respective operations including the image forming operation performed by the printer 20. Processes performed by the controller will be described in detail later.

### Drying Apparatus 30

Next, the drying apparatus 30 is described in detail.

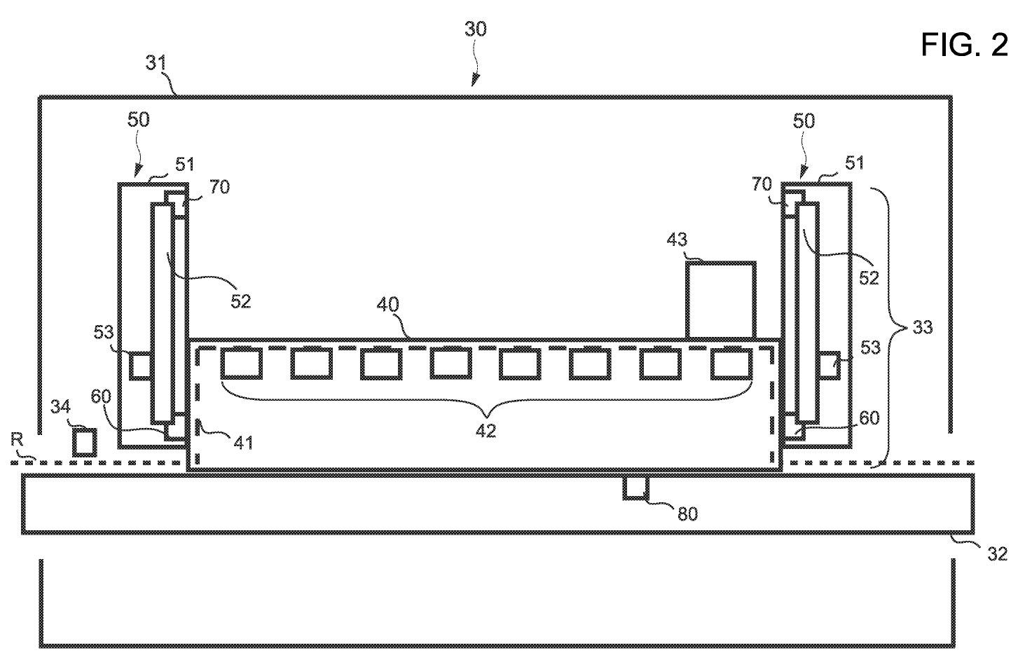

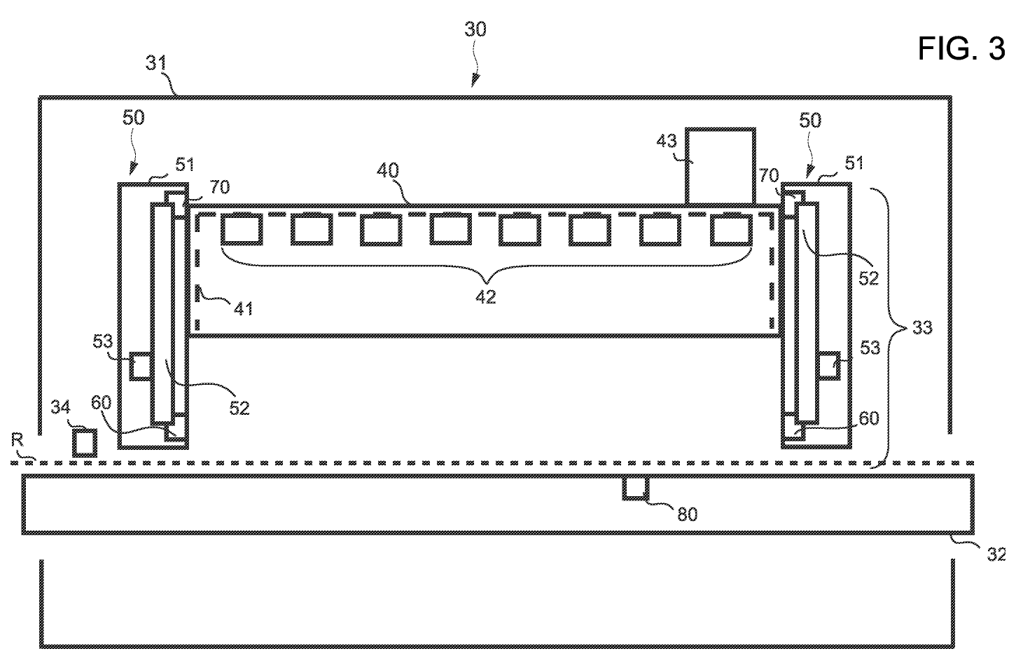

FIGS. 2 and 3 each schematically illustrate an internal configuration of the drying apparatus 30. The drying apparatus 30 is an apparatus that is situated downstream of the printer 20 and that dries ink ejected onto a sheet by the printer 20. As illustrated in the figures, the drying apparatus 30 includes a transportation unit 32 and a drying unit 33 in a rectangular-parallelepiped-shaped body housing 31.

Further, a sensor 34 that detects a paper jam is provided near the transportation unit 32. The paper jam detecting sensor 34 is, for example, a transmissive or reflective optical sensor. When detecting a paper jam, the paper jam detecting sensor 34 outputs a related detection signal to the controller.

Further, doors T (illustrated in FIG. 1) that are open and closed at the time of accessing an interior of the drying apparatus 30 are provided at the front of the body housing. Furthermore, a door sensor (not illustrated) is provided near the doors T. When detecting that the doors T are open, the door sensor outputs a related detection signal to the controller.

The transportation unit 32 is a unit that transports a sheet on which an image is formed. Specifically, the transportation unit 32 causes a sheet transported from the printer 20 to pass through the drying apparatus 30 along a transportation path R in a state in which the sheet is being pulled to a transportation belt by suction. The transportation unit 32 transports the sheet to the post-processing apparatus 90.

The drying unit 33 is a unit that dries ink on a sheet that passes through the drying apparatus 30 on the transportation unit 32. Specifically, the drying unit 33 includes a drier body 40, a movement mechanism 50, position detecting sensors 60 and 70, and a temperature detecting sensor 80.

The drier body 40 is a rectangular-parallelepiped-shaped housing of which a lower portion is open. A heat source 42 is accommodated in an interior 41 of the drier body 40. Note that the heat source 42 is, for example, a halogen heater or a carbon heater, and at least one heat source 42 is accommodated in the drier body 40. Further, a cooling fan 43 is provided on an outer top portion of the drier body 40. The cooling fan 43 cools air in the housing interior 41 by blowing air toward the drier body 40. The cooling fan 43 blows the cooled air downward from an upper surface of the drier body 40.

Note that the drier body 40 is moved between a first position and a second position on the basis of control performed by the controller. Specifically, when the drier body 40 dries ink on a sheet, the drier body 40 is moved to the first position at which the drier body 40 is situated most closely to the transportation unit 32. On the other hand, when a paper jam occurs and when a temperature in a drying space situated between the drier body 40 and the transportation unit 32 is less than a specified threshold, the drier body 40 is moved to the second position at which the drier body 40 is situated most distant from the transportation unit 32. Note that FIG. 2 illustrates the drier body 40 situated at the first position and FIG. 3 illustrates the drier body 40 situated at the second position.

A single movement mechanism is formed of a pair of movement mechanisms 50, and the movement mechanism 50 is a mechanism that moves (slides) the drier body 40 in an up-and-down direction. Specifically, the two movement mechanisms 50 are respectively installed ahead of (on a downstream side) and behind (on an upstream side) the drier body 40 on the basis of a transportation direction for a sheet. Further, the movement mechanism 50 includes, for example, a chassis 51, a rack and pinion 52, a drive motor 53, and a driver IC (not illustrated).

The chassis 51 is a rectangular parallelepiped that is elongated in an up-and-down direction of the body housing 31, and has the rack and pinion 52 built in. The rack and pinion 52 is a mechanism that translates, into a linear motion, a rotational motion of the drive motor 53 serving as a power source. In the present embodiment, racks that are included in the respective movement mechanisms 50 respectively situated ahead of and behind the drier body 40 are arranged to be oriented such that the racks face each other, and the drier body 40 is sandwiched between the racks through fixing devices so that the rotational motion of the drive motor 53 is translated into a linear motion using pinion gears and the racks. This results in moving the drier body 40 between the first position and the second position.

The drive motor 53 is a drive source that is driven on the basis of power supplied by the driver IC and that moves the drier body 40 between the first position and the second position together with the racks. Note that the driver IC can drive the drive motor 53 in a positive direction or a negative direction on the basis of a drive signal provided by the controller.

Further, the movement mechanism 50 is provided with a first position detecting sensor 60 and a second position detecting sensor 70 that detect a position of the drier body 40. Note that a single position detecting sensor is formed of each of a pair of first position detecting sensors 60 and a pair of second position detecting sensors 70.

The first position detecting sensor 60 is a sensor that detects that the drier body 40 (for example, a lower end of the body) is situated at the first position. Further, the second position detecting sensor 70 is a sensor that detects that the drier body 40 (for example, an upper end of the body) is situated at the second position. Note that the first position detecting sensor 60 is installed in a lower portion of the movement mechanism 50 at a position at which the first position detecting sensor 60 faces an open drying space when the drier body 40 is moved to the second position.

The types of the first position detecting sensor 60 and the second position detecting sensor 70 are not limited. For example, transmissive photoelectric sensors are used as the first position detecting sensor 60 and the second position detecting sensor 70. With respect to such position detecting sensors, light (such as infrared light) between a transmission-side sensor installed in one of the movement mechanisms 50 and a reception-side sensor installed in another of the movement mechanisms is blocked by the drier body 40. This enables the position detecting sensor to detect that the drier body 40 is situated at a corresponding position (or has been moved to the position). Further, when detecting the position of the drier body 40, each of the first position detecting sensor 60 and the second position detecting sensor 70 outputs a result of the detection to the controller. Specifically, when detecting that the drier body 40 is situated at a corresponding position, each of the first position detecting sensor 60 and the second position detecting sensor 70 outputs a signal representing "High" (or, for example, "1" or "ON") to the controller. On the other hand, the first position detecting sensor 60 having detected that the drier body 40 has been moved from the first position to the second position, or the second position detecting sensor 70 having detected that the drier body 40 has been moved from the second position to the first position outputs a signal representing "Low" (or, for example, "0" or "OFF") to the controller.

Further, the transportation unit 32 is provided with the temperature detecting sensor 80 (such as a thermistor). The temperature detecting sensor 80 detects a temperature in a space situated between the drier body 40 and the transportation unit 32. Specifically, when the drier body 40 is situated at the first position, the temperature detecting sensor 80 detects a temperature in a drying space formed between the drier body 40 and the transportation unit 32. Further, when the drier body 40 is situated at the second position, the temperature detecting sensor 80 detects a temperature in an open drying space situated above the transportation unit 32. Furthermore, the temperature detecting sensor 80 outputs the detected temperature to the controller.

### Controller 100

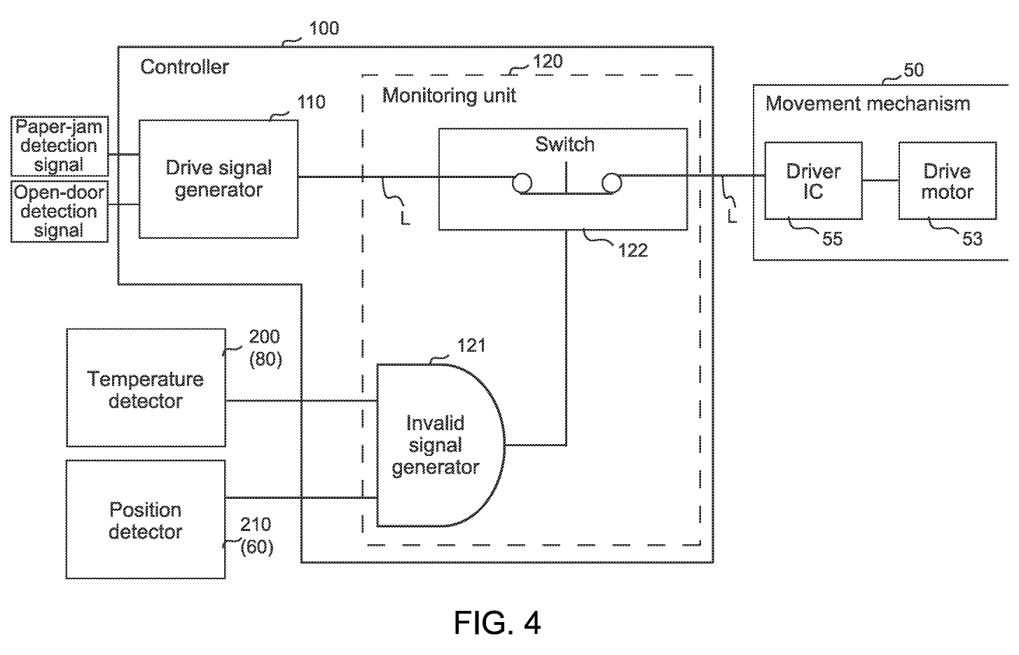

Next, a controller 100 is described. The controller 100 controls operations performed by the respective apparatuses included in the image forming system 1. FIG. 4 illustrates an example of an internal configuration of the controller 100. As illustrated in the figure, the controller 100 includes a drive signal generator 110 and a monitoring unit 120.

The drive signal generator 110 generates a control signal (a drive signal) used to control operation performed by each apparatus included in the image forming system 1, and outputs the generated control signal to the control-target apparatus to perform control. Specifically, the drive signal generator 110 controls the image forming operation performed by the printer 20. Further, the drive signal generator 110 controls the transportation unit 32 of the drying apparatus 30 to transport a sheet onto which ink has been ejected. Furthermore, the drive signal generator 110 operates the heat source 42 when the drier body 40 is situated at the first position.

Further, when an external signal (such as a paper-jam detection signal or an open-door detection signal) is acquired upon occurrence of a paper jam, the drive signal generator 110 stops operation performed by the transportation unit 32. Further, the drive signal generator 110 operates the cooling fan 43 to cool the interior 41 of the drier body 40 while stopping operating the heat source 42.

Further, when a paper jam is detected, the drive signal generator 110 generates a drive signal used to move the drier body 40 from the first position to the second position, and outputs the generated drive signal to a driver IC 55 of the movement mechanism 50.

On the other hand, the monitoring unit 120 monitors at all times whether the temperature in the drying space is greater than or equal to a specified threshold, on the basis of a signal provided by a temperature detector 200 (implemented by the temperature detecting sensor 80). Further, the monitoring unit 120 monitors the position of the drier body 40 at all times on the basis of a signal provided by a position detector 210 (implemented by the first position detecting sensor 60). When the temperature in the drying space is greater than or equal to the specified threshold and when the drier body 40 is situated at the first position, an invalid signal generator 121 of the monitoring unit 120 outputs a signal representing "High" to a switch 122. Note that, when the temperature in the drying space is less than the threshold or when the drier body 40 is not situated at the first position, the invalid signal generator 121 outputs a signal representing "Low" to the switch 122.

The controller 100 performing such a process includes a processor, a memory, an AND circuit, and a switch, and the drive signal generator 110 is implemented by the processor and the memory. Note that the processor is a processing unit such as a central processing unit (CPU). Examples of the memory include nonvolatile and volatile storage media such as a read only memory (ROM), a random access memory (RAM), and an electrically erasable programmable read-only memory (EEPROM). The drive signal generator 110 is implemented by the processor reading and executing a control program stored in the memory.

Further, the monitoring unit 120 includes the invalid signal generator 121 and the switch 122, and the invalid signal generator 121 and the switch 122 are respectively implemented by an AND circuit and a normally closed switch. Note that the switch 122 may be a semiconductor switch such as a transistor, or may be a mechanical switch. The AND circuit is a logic circuit that outputs a control signal representing "High" (such as a voltage signal) only when inputs (in the present embodiment, two inputs from the temperature detector 200 and the position detector 210) each represent "High" (or, for example, "1" or "ON"). Further, the AND circuit outputs a control signal representing "Low" when one of the inputs represents "Low" ("0" or "OFF").

The case in which the temperature detector 200 inputs the signal representing "High" to the AND circuit refers to the case in which the temperature detected in the drying space is greater than or equal to a specified threshold (for example, 50°C). Further, the case in which the position detector 210 inputs the signal representing "High" to the AND circuit refers to the case in which the drier body 40 is situated at the first position. On the other hand, the case in which the temperature detector 200 inputs the signal representing "Low" to the AND circuit refers to the case in which the temperature detected in the drying space is less than the specified value (for example, 50°C) or the case in which the drier body 40 is not situated at the first position.

The switch 122 is a normally closed switch. Thus, when "High" is input by an AND circuit, the switch 122 shuts off a signal line L between the drive signal generator 110 and the driver IC 55 of the movement mechanism 50.

In other words, when a paper jam occurs, the controller 100 performs control such that the drier body 40 is kept at the first position when the temperature in the drying space is greater than or equal to a specified threshold, and such that the drier body 40 is moved to the second position when the temperature in the drying space drops to less than the specified temperature. Note that the controller 100 performs control such that the heat source 42 does not operate when the drier body 40 is situated at a position other than the first position. The reason is that, if the heat source 42 operates when the drier body 40 is situated at the position other than the first position, heat generated by the heat source 42 may be transferred to the first position detecting sensor 60 to cause the sensor 60 to be damaged. Further, one of the reasons for stopping the heat source 42 when the drier body 40 is situated at the position (such as the second position) other than the first position is that the safety for a user who is removing a jammed sheet is also taken into consideration.

Such control results in making the drying space open after the temperature in the drying space drops to less than a threshold. Thus, a high-temperature air does not flow out of the open drying space. This results in preventing the position detecting sensor arranged at a position at which the position detecting sensor faces the drying space from being damaged.

In particular, the controller 100 monitors the temperature in the drying space at all times, and performs control such that output of a signal used to make the drying space open is stopped when the temperature in the drying space is greater than or equal to a threshold. As a result, a drive signal used to move the drier body 40 from the first position to the second position is not transmitted to the driver IC of the movement mechanism. Thus, a drive signal output from the drive signal generator 110 is disabled. This results in preventing the first position detecting sensor 60 from being subjected to heated air in the drying space, and thus in preventing the sensor from being damaged.

In other words, the image forming system 1 makes it possible to perform control with a high degree of safety such that the driver IC is only enabled when a temperature condition and a sensor position are appropriate. Further, the condition that the drier body 40 be situated at the first position is set to be one of the control conditions in addition to the temperature condition, in order to enhance the safety by input being performed twice by two input elements. This makes it possible to also perform control properly when erroneous detection or failure occurs in one of the types of elements, compared to when it is determined, only using the one of the types of elements, whether to move the drier body 40 or to keep the drier body 40 at the first position.

### Modification

Next, a modification is described. In the embodiment described above, the monitoring unit 120 including an AND circuit and a switch performs a process of disabling control performed to move the drier body 40 to the second position, according to the temperature in the drying space and the position of the drier body 40, although the present disclosure is not limited thereto.

In the image forming system 1 according to the modification, the drive signal generator 110 also performs control to be performed by the monitoring unit 120. Specifically, the drive signal generator 110 acquires signals respectively provided by the temperature detector 200 and the position detector 210, and determines whether the temperature in the drying space is greater than or equal to a specified threshold to control the drying apparatus 30. Note that the processor by which the drive signal generator 110 is implemented reads a program used to perform a process that is similar to the process to be performed by the monitoring unit 120. This results in the control process described above being performed by the drive signal generator 110.

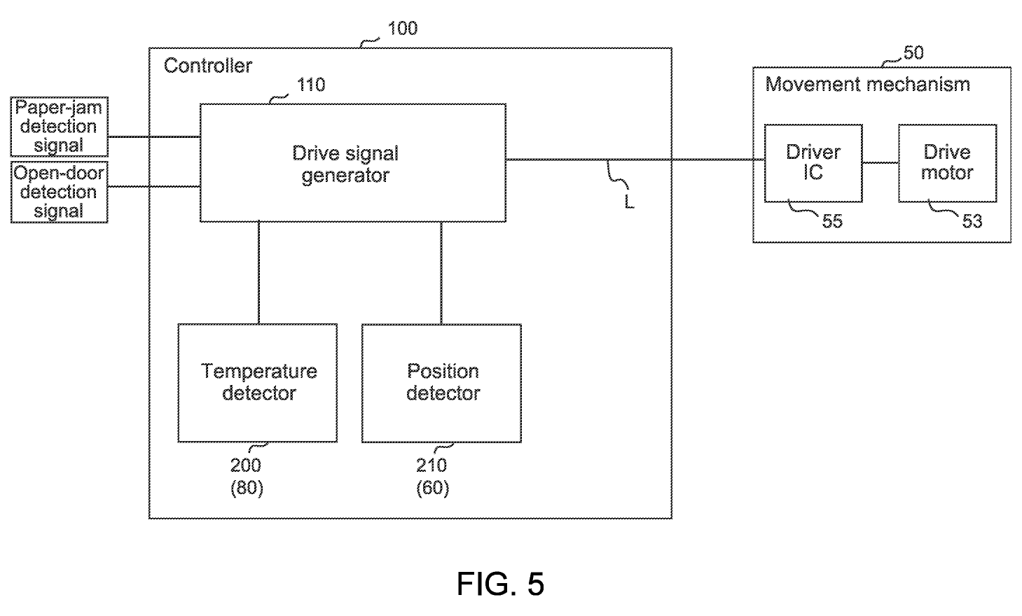

FIG. 5 illustrates an example of the controller according to the modification.

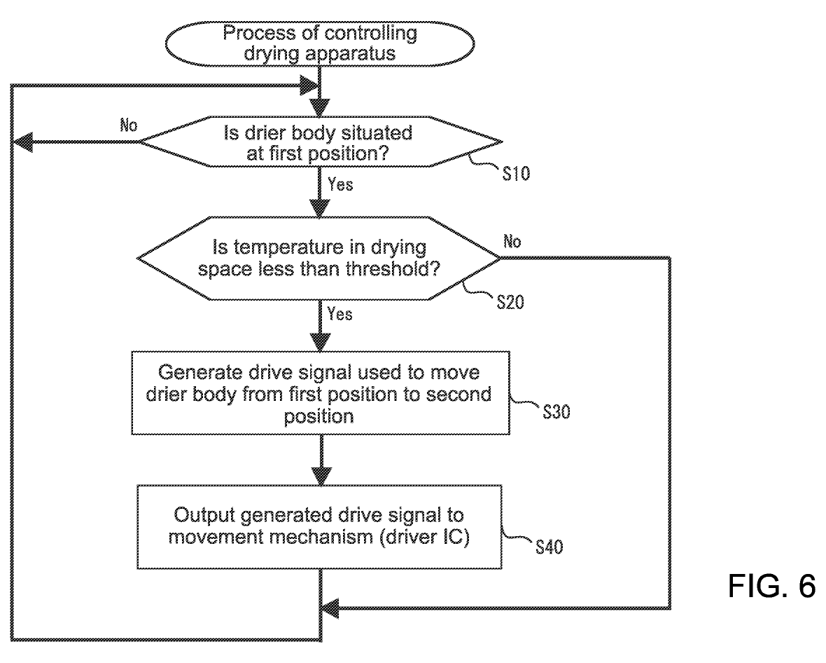

FIG. 6 is a flowchart of an example of the process of controlling the drying apparatus. This process is started concurrently with start of the image forming system 1.

When the process is started, the drive signal generator 110 of the controller 100 determines whether the drier body 40 is situated at the first position (Step S10). Specifically, the drive signal generator 110 determines the position of the drier body 40 on the basis of a detection result acquired from the position detector 210.

When the drive signal generator 110 has determined that the drier body 40 is not situated at the first position (No in Step S10), the drive signal generator 110 performs the process of Step S10 again. On the other hand, when the drive signal generator 110 has determined that the drier body 40 is situated at the first position (Yes in Step S10), the drive signal generator 110 moves on to the process of Step S20.

In Step S20, the drive signal generator 110 determines whether the temperature in the drying space is less than a specified threshold. When the drive signal generator 110 has determined that the temperature in the drying space is not less than the threshold (No in Step S20), the drive signal generator 110 returns to the process of Step S10. In this case, the temperature in the drying space is high. Thus, the position detecting sensor 60 will be damaged if the drying space is made open. Therefore, the drive signal generator 110 returns to the process of Step S10 without generating a drive signal used to move the drier body 40 to the second position.

On the other hand, when the drive signal generator 110 has determined that the temperature in the drying space is less than the threshold (Yes in Step S20), the drive signal generator 110 generates the drive signal used to move the drier body 40 from the first position to the second position (Step S30). Further, the drive signal generator 110 outputs the generated drive signal to the driver IC 55 of the movement mechanism 50, and returns to the process of Step S10.

The process of controlling the drying apparatus has been described above. The image forming system 1 described above makes it possible to perform, using software and a processing unit, control upon occurrence of a paper jam without damaging the sensor included in the drying apparatus 30, as in the case in which the monitoring unit 120 including hardware is provided. In other words, the image forming system according to the modification makes it possible to prevent the position sensor situated near the drying space from being damaged, on the basis of control performed using software.

Although the embodiments of the present disclosure have been described above, of course the present disclosure is not limited to the embodiments described above, and various modifications may be made thereto.

What is claimed is:

1. An image forming system, comprising:
an image forming apparatus that forms an image on a sheet; and
a drying apparatus that dries ink ejected onto the sheet,
the drying apparatus including
a transportation unit that transports, along a transportation path, the sheet on which the image has been formed,
a drying unit that includes
a drier body that has a heat source built in, with a drying space used to dry the sheet being formed between the drier body and the transportation unit when the drier body is situated at a first position, the drying space being made open when the drier body is situated at a second position, and
a movement mechanism that moves the drier body between the first position and the second position,
a position detector that is installed near the drying space, the position detector detecting a position of the drier body,
a temperature detector that detects a temperature in the drying space, and
a controller that is capable of generating, upon acquiring an external signal, a drive signal used to move the drier body from the first position to the second position, the controller performing a disabling process when the temperature in the drying space is greater than or equal to a specified threshold, the disabling process being performed to disable output of the drive signal.

2. The image forming system according to claim 1, wherein
the controller includes
a drive signal generator that generates, upon acquiring the external signal, the drive signal used to move the drier body from the first position to the second position, and that outputs the generated drive signal to the movement mechanism, and
a monitoring unit that includes
a switch that connects a signal line between the drive signal generator and the movement mechanism, and
a signal generator that performs the disabling process when a signal indicating that the temperature in the drying space is greater than or equal to the threshold is acquired from the temperature detector, the disabling process including generating a control signal used to shut off the signal line and outputting the generated control signal to the switch.

3. The image forming system according to claim 1, wherein,
upon acquiring the external signal, the controller determines whether the temperature in the drying space is greater than or equal to the threshold,
when the temperature in the drying space is less than the threshold, the controller generates the drive signal used to move the drier body from the first position to the second position, and outputs the generated drive signal to the movement mechanism, and
when the temperature in the drying space is greater than or equal to the threshold, the controller keeps the drier body at the first position without generating the drive signal.

4. The image forming system according to claim 1, wherein
the position detector includes
a second position detecting sensor that detects the second position, and
a first position detecting sensor that detects the first position, the first position detecting sensor being situated closer to the transportation unit than the second position detecting sensor, and
the first position detecting sensor is provided at a position at which the first position detecting sensor faces the open drying space when the drying space is made open by the drier body being moved to the second position.

5. The image forming system according to claim 1, wherein,
when the temperature in the drying space is greater than or equal to the specified threshold and when the drier body is situated at the first position, the controller performs the disabling process.

6. The image forming system according to claim 1, wherein
the drier body further includes a cooling fan that cools a temperature in the drier body by blowing outside air.
